(19) United States
(12) Patent Application Publication
(10) Pub. No.: US 2006/0106929 A1
(43) Pub. Date: May 18, 2006

(54) Network conference communications

(76) Inventors: Michael L. Kenoyer, Austin, TX (US); Ashish Goyal, Karnataka (IN); Michael J. Burkett, Austin, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/252,189

(22) Filed: Oct. 17, 2005

Related U.S. Application Data
(60) Provisional application No. 60/619,210, filed on Oct. 15, 2004.
(60) Provisional application No. 60/676,665, filed on Apr. 29, 2005.

(51) Int. Cl. G06F 15/173

(52) U.S. Cl. 709/224

(57) ABSTRACT

In some embodiments, two or more packets of a first protocol including data of a real time protocol (RTP) which is associated with audio and/or video conferencing information may be received at a first interface. Two or more data channels may couple the first interface to a second interface via various networks, and each of the two or more data channels may include network sockets of a second protocol. Any number of N data channels may be used based on various configurations. The two or more packets of the first protocol may be sent from the first interface to the second interface via the two or more data channels. In various embodiments, a first RTP may be received and transcoded into a second RTP, and data from a first codec associated with the first RTP to data of a second codec associated with the second RTP.

### PRIORITY CLAIM

This application claims benefit of priority of U.S. Provisional Patent Application Ser. No. 60/619,210 titled “VIDEO CONFERENCE CALL SYSTEM” filed on Oct. 15, 2004, whose inventors are Jonathan W. Tracey, Craig B. Malloy, Michael L. Kenoyer, Michael V. Jenkins, Ashish Goyal, and Michael J. Burkett which is hereby incorporated by reference in its entirety as though fully and completely set forth herein.

This application also claims benefit of priority of U.S. Provisional Patent Application Ser. No. 60/676,665 titled “Video and Audio Connectivity Service With Video Bridging and Tunneling UDP Optionally Encapsulated in HTTP over Multiple TCP for Firewall Traversal” filed on Apr. 29, 2005, whose inventors are Jonathan W. Tracey, Craig B. Malloy, Michael L. Kenoyer, Michael V. Jenkins, Ashish Goyal, and Michael J. Burkett which is hereby incorporated by reference in its entirety as though fully and completely set forth herein.

### BACKGROUND OF THE INVENTION

1. Field of the Invention

The present invention relates generally to communication systems and, more specifically, to video conference systems.

2. Description of the Related Art

Conference calls (e.g., audio and/or video) may be difficult to place and/or conduct over an Internet protocol (IP) network, such as the Internet. IP traffic over the IP network may be subject to various delays, packet corruption, and/or packet losses. Real time traffic such as audio (e.g., voice) and/or video over IP may result in poor or even unusable communications because of the delays, packet corruption, and/or packet losses.

In addition, some gateways coupling a conference system to a network, such as the Internet, can include firewalls and/or packet filtering mechanisms that may not allow user datagram protocol (UDP) packets (often used in audio and/or video transmissions) to be communicated with the IP network. For example, UDP packets may be perceived as less secure than other available transfer protocols (e.g., transmission control protocol (TCP), hypertext transfer protocol (HTTP), and/or secure hypertext transfer protocol (HTTPS), etc.), among other reasons. However, the use of other protocols (e.g., TCP, HTTP, HTTPS) may add substantial and/or undesirable delays that may adversely affect transmission of audio and/or video streams for conferences conducted via the IP network. If the data is communicated over a network connection via two or more TCP packets and one of the packets does not arrive, the other packet(s) may be queued, and the lost packet may be requested to be resent. When the resent packet is received, all of the packets may be sent to the application. However, there may be a substantial delay while waiting for the requested packet to be resent. That delay may affect audio and/or video quality for one or more users.

Furthermore, some gateways may include network address translation (NAT) mechanisms that may be troublesome for interactive multimedia communications such as those established and managed by a real time protocol (e.g., session initiation protocol (SIP), H.261, H.263, H.264, H.323, streaming audio and/or video protocol, etc.). For example, NAT can map IP addresses from one realm to another. For instance, NAT can be used to connect an address realm with private unregistered addresses to an external realm with various globally unique and/or public addresses (e.g., publicly routable IP addresses). In an example, a first computer system coupled to the IP network through a gateway (e.g., an internal host behind the NAT) may initiate a connection with a second computer system (e.g., an external host not behind the NAT). The first computer system can send a packet with a private source IP address (e.g., 192.168.1.45). The NAT mechanism in the gateway may translate the source address to a public address (e.g., 212.45.88.102) and forward the packet to the second computer system. However, the second computer system may not initiate a connection with the first computer system using the public address, since more than one computer system behind the gateway may be using the public address or the gateway may not allow any connections initiated from a computer system outside the gateway to a computer system inside the gateway.

Moreover, computer systems coupled to the IP network are not reachable from a plain old telephone system (POTS) telephone via a public switched telephone network (PSTN), e.g., cannot be reached with a telephone number which can be dialed from the PSTN. Furthermore, a conference unit coupled to the PSTN via an Integrated Services Digital Network (ISDN) connection using H.320 cannot participate in a conference if the computer systems coupled to the IP are using a real time protocol (e.g., session initiation protocol (SIP), H.261, H.263, H.264, H.323, streaming audio and/or video protocol, etc.). There is not an option for transcoding (e.g., converting) H.320 to and from a real time protocol nor is there an option for transcoding among real time protocols, e.g., to and from SIP and H.323, to and from H.264 and H.323, etc.

### SUMMARY OF THE INVENTION

In various embodiments, two or more data channels may be created between a first interface and a second interface, and the two or more data channels may couple the first interface to the second interface via various networks. Any number of N data channels may be used based on various configurations. Two or more packets of a first protocol may be received at the first interface. For instance, the first protocol may include user datagram (UDP) packets. In some embodiments, each of the two or more data channels may include network sockets of a second protocol. For instance, the second protocol may include one or more of transmission control protocol (TCP), hypertext transfer protocol (HTTP), and/or secure hypertext transfer protocol (HTTPS), among others. The two or more packets of the first protocol may include data of a real time protocol (e.g., session initiation protocol (SIP), H.323, streaming audio and/or video protocol, etc.) for audio and/or video information. In some embodiments, the two or more packets of the first protocol comprising data of the real time protocol may be sent from the first interface to the second interface via the two or more data channels of the second protocol.

In some embodiments, each data channel of the two or more data channels may be controlled and/or operated by a respective thread and/or process, and each respective thread and/or process may be synchronized with other threads and/or processes or may perform in an asynchronous manner with respect to other threads and/or processes.

In an example, a first data channel of the two or more data channels (e.g., network data sockets) of the second protocol may be determined, and a first packet of the two or more packets of the first protocol may be transmitted via the first data channel to the second interface. A second data channel of the two or more data channels of the second protocol may be determined, and a second packet of the two or more packets of the first protocol may be transmitted via the second data channel to the second interface. Other packets may be sent via various other data channels or through the first and/or the second data channels. In some embodiments, various error resiliency schemes may be used. Some errors may be ignored and/or some errors may be corrected by resending corrupted, lost, or timed-out packets. In various embodiments, the second protocol may include transport layer security (TLS), HTTPS (secure HTTP), and/or a secure socket layer (SSL), among other security methods and/or mechanisms.

In various embodiments, various computer systems may be coupled to a network (e.g., the Internet) via a gateway that may include firewall, network address translation (NAT), packet filter, and/or proxy mechanisms, among others. The gateway may not allow the computer systems to communicate with the network using one or more protocols (e.g., UDP, NETBIOS™, Internet control message protocol, AppleTalk™, etc.). For instance, a policy may be set to exclude using UDP to communicate with the network, since UDP may be perceived as less secure than other available transfer protocols (e.g., TCP, HTTP, HTTPS, etc.). In some embodiments, the gateway may allow the computer systems to communicate with the network using TCP, HTTP, HTTPS, etc. In various embodiments, various applications, such as audio and/or video applications, use UDP for communications that may not be allowed by the gateway.

In some embodiments, two or more data channels may be created between a first interface and a second interface, where a first computer system coupled to the network through the gateway includes or is coupled to the first interface and a second computer system coupled to the network includes or is coupled to the second computer system. As described herein, the two or more data channels may be used to communicate and/or encapsulate UDP packets from the first computer system to the second computer system via the two or more data channels, since the two or more data channels use a protocol that is allowed by the gateway.

In some embodiments, the gateway may be using NAT in communicating data with the network and the various computer systems coupled to the gateway. For example, the computer systems may use private IP addresses that may not be recognized by the network and/or other computer systems coupled to the network. Furthermore, the gateway may use NAT to enable a single public address (e.g., a single public IP address) to be used by the computer systems, coupled to the gateway, in making outgoing connections to the network and/or other computer systems coupled to the network. In some embodiments, connections incoming from the network and/or other computer systems coupled to the network to the single public address may not be used by the computer systems coupled to the gateway, since it may be difficult to differentiate which computer system coupled to the gateway is to receive the incoming connection. Furthermore, the gateway may be configured to block any connections which are incoming to the computer systems coupled to the network through the gateway. In some embodiments, a service provider (e.g., a computer system coupled to the network) may be used to provide access of incoming connections from the network to computer systems coupled to the gateway.

In various embodiments, the service provider may include one or more mechanisms to obtain a public address (e.g., a publicly routable address), “listen” for incoming traffic sent to the public address, and send incoming traffic to a computer system (e.g., a privately address endpoint) coupled to the gateway. For example, two or more data channels may be set up between a computer system coupled to the network through the gateway and the service provider. The service provider may accept incoming connections on behalf of the computer system coupled to the network through the gateway and communicate various data associated with incoming connections through the two or more data channels. In other words, the service provider may be operable to act as an agent or client on behalf of various computer systems coupled to the network through the gateway. This may allow a computer system coupled to the gateway to receive incoming connections from the network and/or a computer system coupled to the network even though the gateway may use NAT or the gateway may not allow incoming connections to the computer systems coupled to it.

In some embodiments, a computer system (e.g., a service provider, an endpoint, etc.) may perform transcoding of one or more real time protocols (e.g., SIP, H.320, H.323, etc.). For example, the computer system may receive a first real time protocol and may transcode the first real time protocol into a second real time protocol. In some embodiments, transcoding the first real time protocol into the second real time protocol may include a process of converting the first real time protocol into the second real time protocol. For example, data from a first codec (e.g., data encoding/decoding method, scheme, and/or mechanism) associated with the first real time protocol to data of a second codec associated with the second real time protocol. In other words, transcoding may include a process of converting media data or object from one format to another. In various embodiments, transcoding may be used to convert video formats. For example, transcoding may be used to convert Windows Media™ to QuickTime™, QuickTime™ to MPEG, MPEG to QuickTime™, etc. In an example, the computer system may transcode H.323 into H.320. In another example, the computer system may transcode H.320 into one or more of SIP, H.323 or streaming audio or video using H.261, H.263, H.264, H.323, streaming audio and video protocol, among others. In yet another example, the computer system may transcode one or more of SIP, H.261, H.263, H.264, H.323, streaming audio and video protocol, among others, to H.320. Audio protocols such as G.711, G.728, G.723, G.729, G.722, G.722.1, G.722.1 Annex C, MPEG-4-AAC and others may also be transcoded.

In various embodiments, a computer system, such as a service provider, may include various services and/or features to various computer systems (e.g., endpoints, conference systems, etc.). For example, telephone number dialing may be provided to one or more computer systems. In an instance, the service provider may enable one or more computer systems to dial a telephone number associated with a public switched telephone network (PSTN) and/or a plain old telephone system (POTS) telephone (e.g., landline telephone, cellular telephone, satellite telephone, wireless telephone, etc.). In another instance, the service provider may provide one or more computer systems with a telephone number such that each may receive communications initiated from the PSTN and/or a device (e.g., POTS telephones, conferences units, etc.) coupled to the PSTN. For example, the service provider may bridge one or more of conference units using H.320 with one or more computer systems coupled to an Internet protocol (IP) network, such as the Internet, using one or more real time protocols (e.g., SIP, H.323, etc.).

In some embodiments, the service provider may provide various identification systems and/or methods to the computer systems coupled to the network. For example, the service provider may provide various network identifications to the computer systems. In various instances, the service provider may provide one or more of a URI (Uniform Resource Identifier), URL (Uniform Resource Locator), an IP address, a fully qualified domain name (e.g., “endpoint.somedomain.com”, etc.), an identification at an address or domain (e.g., “name@domain”, “name@endpoint.somedomain.com”, etc.), a telephone number accessible from a PSTN, among others, to each of the computer systems.

### BRIEF DESCRIPTION OF THE DRAWINGS

A better understanding of the present invention may be obtained when the following detailed description is considered in conjunction with the following drawings, in which:

FIG. 1 is a block diagram that illustrates a network communication system, according to various embodiments;

FIGS. 2A-2D are block diagrams that illustrate various prior art protocol stacks;

FIGS. 2E-2F are block diagrams that illustrate exemplary protocol stacks, according to various embodiments;

FIG. 3 is a block diagram that illustrates communicating using a first protocol over multiple data channels of a second protocol, according to various embodiments;

FIG. 4A is a flowchart diagram illustrating a method for communicating using a first protocol over multiple data channels of a second protocol, according to various embodiments;

FIG. 4B is a flowchart diagram illustrating a method for communicating using a first protocol over multiple data channels of a second protocol, according to various embodiments;

FIGS. 5A-5K are block diagrams that illustrate various aspects of communicating using a first protocol over multiple data channels of a second protocol, according to various embodiments;

FIG. 6 is a flowchart that illustrates a method for using a service provider to communicate with a computer system, according to various embodiments;

FIG. 7 is a flowchart which illustrates a method for using a service provider to provide access of a network, according to various embodiments; and

FIG. 8 is a flowchart that illustrates a method for transcoding real time protocols, according to various embodiments.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

Incorporation by Reference

U.S. Provisional Patent Application titled “Speakerphone”, Ser. No. 60/619,303, which was filed Oct. 15, 2004, whose inventors are William V. Oxford, Michael L. Kenoyer, and Simon Dudley is hereby incorporated by reference in its entirety as though fully and completely set forth herein.

U.S. Provisional Patent Application titled “Speakerphone”, Ser. No. 60/634,315 which was filed Dec. 8, 2004, whose inventors are William V. Oxford, Michael L. Kenoyer and Simon Dudley which is hereby incorporated by reference in its entirety as though fully and completely set forth herein.

U.S. Provisional Patent Application titled “Video Conferencing Speakerphone”, Ser. No. 60/619,212, which was filed Oct. 15, 2004, whose inventors are Michael L. Kenoyer, Craig B. Malloy, and Wayne E. Mock is hereby incorporated by reference in its entirety as though fully and completely set forth herein.

U.S. Provisional Patent Application titled “High Definition Camera and Mount”, Ser. No. 60/619,227, which was filed Oct. 15, 2004, whose inventors are Michael L. Kenoyer, Patrick D. Vanderwilt, Paul D. Frey, Paul Leslie Howard, Jonathan I. Kaplan, and Branko Lukic, is hereby incorporated by reference in its entirety as though fully and completely set forth herein.

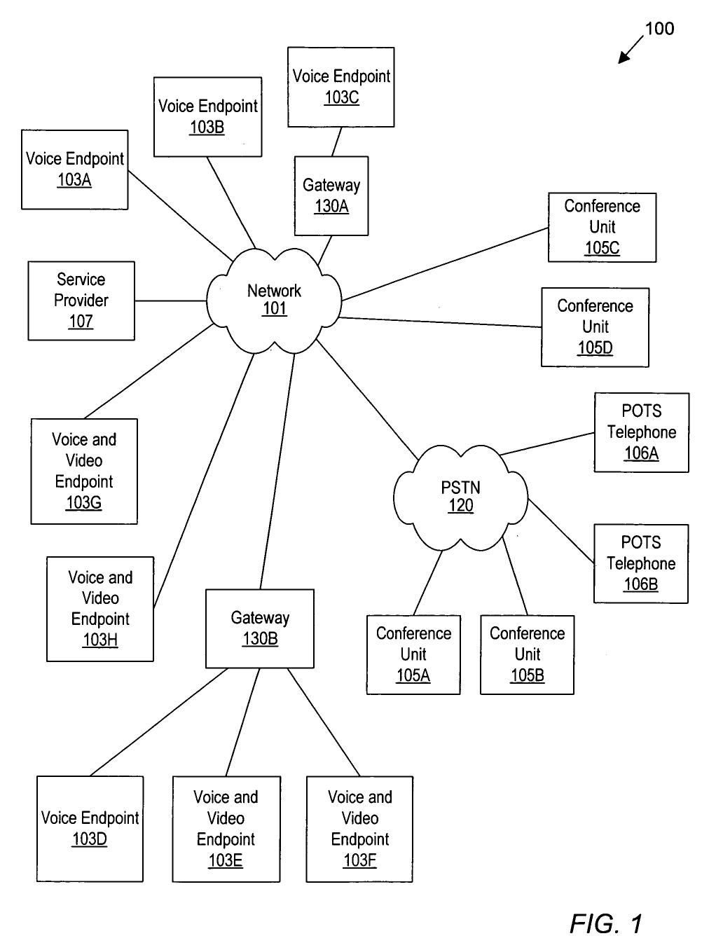

FIG. 1—A Network Communications System

FIG. 1 illustrates an embodiment of a network communication system 100 which may include a network 101, endpoints 103A-103H, gateways 130A-130B, a service provider 107 (e.g., a multipoint control unit (MCU)), a public switched telephone network (PSTN) 120, conference units 105A-105D, and plain old telephone system (POTS) telephones 106A-106B. Endpoints 103A-103H, gateways 130A-130B, service provider 107, and PSTN 120 may be coupled to network 101. Endpoints 103C and 103D-103H may be coupled to network 101 via gateways 130A and 130B, respectively, and gateways 130A and 130B may each include firewall, network address translation (NAT), packet filter, and/or proxy mechanisms, among others. Conference units 105A-105B and POTS telephones 106A-106B may be coupled to network 101 via PSTN 120. In some embodiments, conference units 105A-105B may each be coupled to PSTN 120 via an Integrated Services Digital Network (ISDN) connection, and each may include and/or implement H.320 capabilities.

In some embodiments, endpoints 103A-103H, gateways 130A-130B, conference units 105C-105D, and service provider 107 may each include various wireless or wired communication devices, such as a wireless Ethernet (e.g., IEEE 802.11) card, IEEE 802.16, paging logic, RF (radio frequency) communication logic, a wired Ethernet card, a modem, a digital subscriber line (DSL) device, a cable (television) modem, an ISDN device, an ATM (asynchronous transfer mode) device, a satellite transceiver device, a parallel or serial port bus interface, and/or other type of communication device.

In various embodiments, the methods and/or systems described may be used to implement connectivity between or among two or more voice and/or video devices (e.g., endpoints 103A-103H, conference units 105A-105D, POTS telephones 106A-106B, etc.) that communicate through various networks (e.g., network 101, PSTN 120, the Internet, etc.). Endpoints 103A-103C may include voice conferencing capabilities and include or be coupled to various audio devices (e.g., microphones, audio input devices, speakers, audio output devices, telephones, speaker telephones, etc.). Endpoints 103D-103H may include voice and video communications capabilities (e.g., video conferencing capabilities) and include or be coupled to various audio devices (e.g., microphones, audio input devices, speakers, audio output devices, telephones, speaker telephones, etc.) and include or be coupled to various video devices (e.g., monitors, projectors, displays, televisions, video output devices, video input devices, cameras, etc.). In some embodiments, endpoints 103A-103H may include various ports for coupling to one or more devices (e.g., audio devices, video devices, etc.) and/or to one or more networks.

Conference units 105A-105D may include voice and/or video conferencing capabilities and include or be coupled to various audio devices (e.g., microphones, audio input devices, speakers, audio output devices, telephones, speaker telephones, etc.) and/or include or be coupled to various video devices (e.g., monitors, projectors, displays, televisions, video output devices, video input devices, cameras, etc.). In some embodiments, endpoints 103A-103H and/or conference units 105A-105D may include and/or implement various network media communication capabilities. For example, endpoints 103A-103H and/or conference units 105C-105D may each include and/or implement one or more real time protocols, e.g., session initiation protocol (SIP), H.261, H.263, H.264, H.323, among others. In various embodiments, a real time protocol may include a codec. In some embodiments, a codec (which stands for “compressor/decompressor”) may include any system and/or method for encoding and/or decoding (e.g., compressing and decompressing) data (e.g., audio and/or video data). For example, communication applications may use codecs to convert an analog signal to a digital signal for transmitting over various digital networks (e.g., network 101, PSTN 120, the Internet, etc.) and to convert the digital signal to an analog signal. In various embodiments, codecs may be implemented in software, hardware, or a combination of both. Some codecs for computer video and/or audio may include MPEG, Indeo™, and Cinepak™, among others.

In some embodiments, service provider 107 may provide various services and/or features to endpoints 103A-103H. For example, telephone number dialing may be provided to one or more endpoints 103A-103H via the service provider 107. In an instance, service provider 107 may enable one or more endpoints 103A-103H to dial a telephone number associated with PSTN 120 and/or POTS telephone 106A. In another instance, service provider 107 may provide each of one or more endpoints 103A-103H with a telephone number such that each may receive communications initiated from PSTN 120 and/or a device (e.g., POTS telephones 106A-106B, conferences units 105A-105B, etc.) coupled to PSTN 120. For example, service provider 107 may bridge one or more of conference units 105A-105B using H.320 with one or more real time protocols (e.g., SIP, H.261, H.263, H.264, H.323, etc.) for use with one or more endpoints 103A-103H and/or conference units 105C-105D coupled to network 101. In some embodiments, service provider 107 may provide various identification systems and/or methods to endpoints 103A-103H. For example, service provider 107 may provide various network identifications to endpoints 103A-103H. In various instances, service provider 107 may provide one or more of a URI (Uniform Resource Identifier), URL (Uniform Resource Locator), an IP address, a fully qualified domain name (e.g., “endpoint.somedomain.com”, etc.), an identification at an address or domain (e.g., “name@domain”, “name@endpoint.somedomain.com”, etc.), a telephone number accessible from a PSTN, among others, to each of one or more of the endpoints 103A-103H.

In some embodiments, the service provider 107 may improve and/or enable connectivity through various networks and/or various network protocols. For example, service provider 107 may enable endpoint 103A to use a real time protocol (e.g., SIP, H.323, etc.) to communicate with conference unit 105A that may use H.320 and/or a plain old telephone system (POTS) telephone or a wireless (e.g., cellular, satellite, etc.) telephone coupled to PSTN 120.

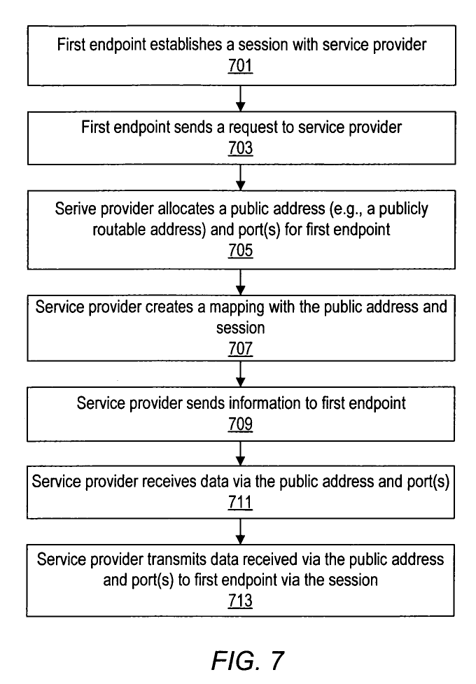

In various embodiments, service provider 107 may enable one or more endpoints 103A-103H with one or more abilities to traverse various firewalls, packet filters, and/or network address translation schemes. For example, network address translation (NAT) may allow two or more computer systems to use a single Internet protocol (IP) address and/or provide an additional layer of security and/or abstraction to one or more computer systems. In some applications, some consequences of using NAT may not be desirable. For example, when two or more computer systems are using a single IP address via NAT, it may not be possible to initiate a network or socket connection with one of the computer systems from a computer system outside the NAT (e.g., from a computer system coupled to network 101 such as endpoints 103A-103B, 103G-103H, conference units 105C-105D, etc.). For instance, gateway 130B may implement and use NAT in providing network access to endpoints 103D-103F, and endpoints 103D-103F may share a single IP address associated with network 101. Thus, in this instance, it may be difficult to establish a connection from a computer system outside the NAT, since two or more of the endpoints 103D-103F may only be accessible outside the NAT through the single IP address associated with network 101. In some embodiments, service provider 107 may provide each of the endpoints 103D-103F with an IP address associated with network 101 and usable for contacting each endpoint even though gateway 130B may be using a NAT scheme for each of the endpoints 103D-103F. This is explained in further detail below with reference to FIG. 7.

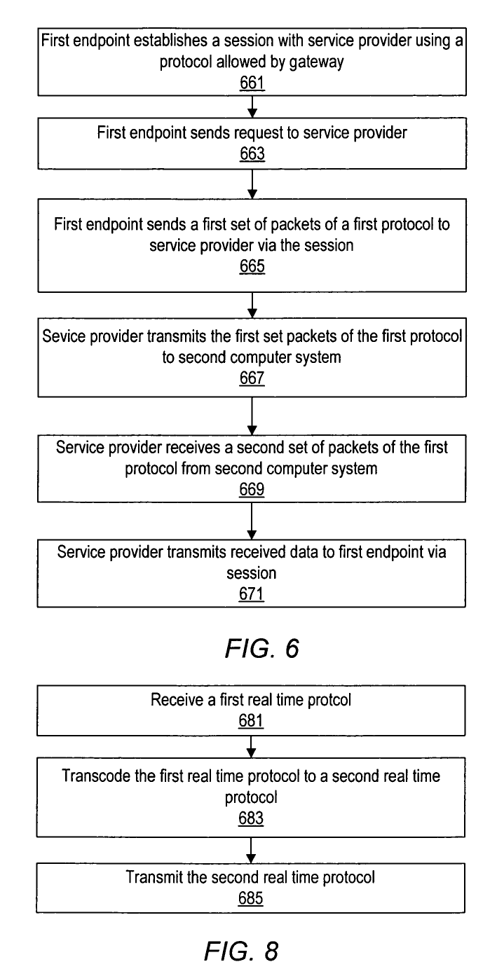

In various embodiments, a firewall and/or a packet filter may be configured to allow certain types of packets to traverse the firewall while blocking other types of packets. For example, each of the gateways 130A-130B may include and/or implement a firewall and/or a packet filter, and each of the gateways 130A-130B may include one or more computer systems to implement various firewalls, packet filters, proxies, and/or network address translation mechanisms. For instance, gateway 130A may allow transmission control protocol (TCP) packets to be communicated with network 101 while blocking user datagram protocol (UDP) packets. Thus, in this instance, endpoint 103C may communicate with network 101 through TCP but not UDP. Service provider 107 may enable endpoint 103C to use UDP in communicating with network 101 and/or computer systems coupled to network 101. This is explained in further detail below with reference to FIG. 6.

In various embodiments, network 101 may include and/or be coupled to other types of communications networks, where endpoints 103A-103H, gateways 130A-130B, and service provider 107 may send and receive information from/to each other, PSTN 120 and/or other communication networks. In some embodiments, network 101 thus may include and/or be coupled to, any of various wide area networks (WANs), local area networks (LANs), corporate networks, including the Internet. In some embodiments, endpoints 103A-103H, network 101, and/or service provider 107 may use one or more secure methods and/or secure techniques for communication. In various embodiments, network 101 may include PSTN 120 or a portion of PSTN 120.

Network 101 may include one or more wireless networks, e.g., based on satellite communications, based on one or more cellular telephone systems, based on IEEE 802.11 and/or IEEE 802.16, etc. Network 101 may include one or more wired networks, e.g., based on Ethernet. Network 101 may include one or more DSL and/or cable (e.g., cable television) networks and/or infrastructures. For example, network 101 may include one or more of: cable modems, cable modem termination systems (CMTSs), satellite modems, DSL modems, digital subscriber line access multiplexers (DSLAMs), broadband remote access servers (BRASs), and/or metropolitan area networks (MANs), among others. Network 101 may form part of the Internet, or may couple to other networks, e.g., other local or wide area networks, such as the Internet. Thus, endpoints 103A-103H and/or service provider 107 may be coupled together using a PSTN, an Ethernet cable, DSL, ISDN, a cable (television) based network, a satellite-based system, and/or a fiber based network, among others.

Memory Medium and Carrier Medium

One or more of the systems described above, such as endpoints 103A-103H, gateways 130A-130B, service provider 107, conference units 105A-105D, etc. may each include a CPU or processing unit and a memory medium on which computer programs or data according to the present invention may be stored. For example, each of the endpoints 103A-103H, gateways 130A-130B, service provider 107, and/or conference units 105A-105D may store a data structure comprising information regarding identification information, corresponding networks, and access information such as associated data routes and/or routing methods. Each of the endpoints 103A-103H, gateways 130A-130B, service provider 107, conference units 105A-105D may further store a software program for accessing these data structures and using the information therein to properly provide or route data between and/or among the systems and networks, or to selectively provide or route data depending on access information.

The term “memory medium” is intended to include various types of memory or storage, e.g., a Compact Disc Read Only Memory (CD-ROM), a floppy disk, a random access memory or computer system memory such as Dynamic Random Access Memory (DRAM), Static Random Access Memory (SRAM), Extended Data Out Random Access Memory (EDO RAM), Rambus Random Access Memory (RAM), Non-Volatile Random Access Memory (NVRAM), Erasable Programmable Read-Only Memory (EPROM), Electrically Erasable Programmable Read-Only Memory (EEPROM), flash memory, etc., or a non-volatile memory such as a magnetic media, e.g., a hard drive, optical storage, etc. The memory medium may include other types of memory as well, or combinations thereof. In addition, the memory medium may be located in a first computer in which the programs are executed, or may be located in a second different computer that connects to the first computer over a network. In the latter instance, the second computer provides the program instructions to the first computer for execution. The memory medium may also be a distributed memory medium, e.g., for security reasons, where a portion of the data is stored on one memory medium and the remaining portion of the data may be stored on a different memory medium. Also, the memory medium may be one of the networks to which the current. network is coupled, e.g., a SAN (Storage Area Network).

Also, each of the systems described above may take various forms, including a personal computer system, mainframe computer system, workstation, network appliance, Internet appliance, personal digital assistant (PDA), an embedded computer system, television system or other device. In general, the term “computer system” can be broadly defined to encompass any device having a processor that executes instructions from a memory medium.

The memory medium in one or more of the above systems thus may store a software program or data for performing or enabling access or selective communication and/or conference network access. A CPU or processing unit in one or more of the above systems executing code and data from a memory medium includes a means for executing the software program according to the methods or flowcharts described below.

Various embodiments further include receiving or storing instructions and/or data implemented in accordance with the present description upon a carrier medium. Suitable carrier media may include memory media as described above, as well as signals such as electrical, electromagnetic, or other forms of analog or digital signals, conveyed via a communication medium such as networks and/or a wireless link. Some embodiments further include computer-readable data signals embodied in one or more carrier media and/or carrier waves that include data and/or instructions implemented in accordance with the present description.

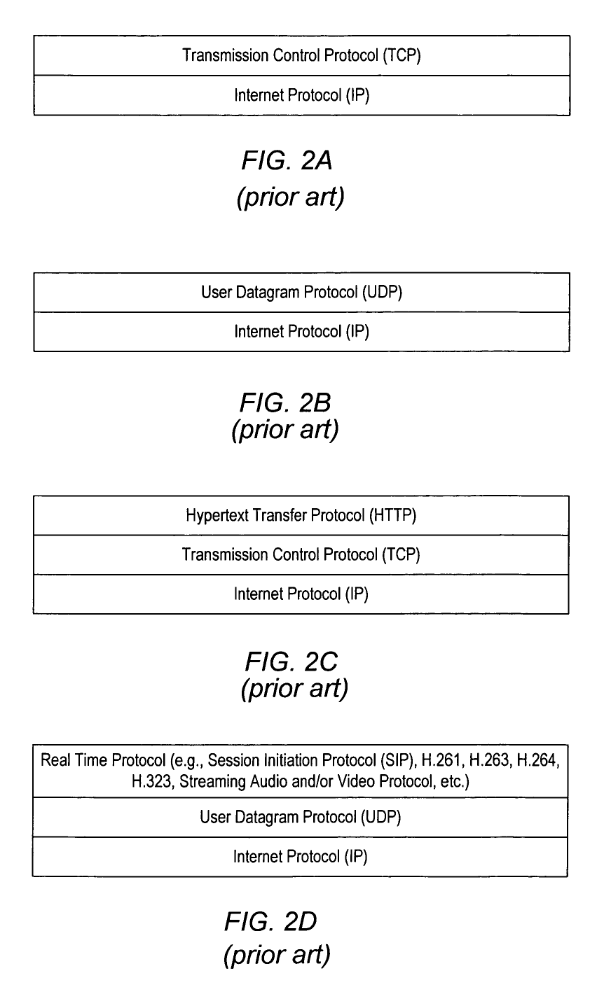

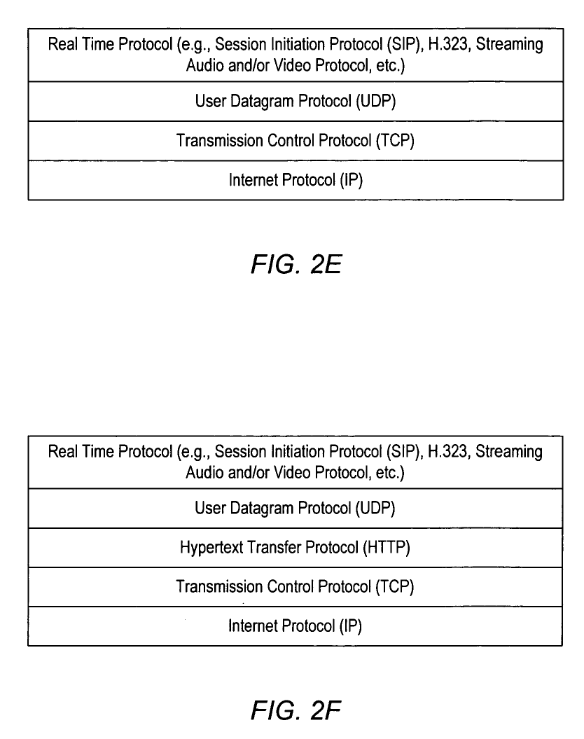

FIGS. 2A-2G—Protocol Stacks

FIGS. 2A-2D illustrate prior art protocol stacks, and FIGS. 2E-2F illustrate various protocol stacks, according to various embodiments.

Sometimes protocols may be referred to as being “stacked” on one another, thereby creating a protocol stack. For example, as shown in FIG. 2A, TCP is stacked on IP. This illustrates that communications using IP include using TCP packets. Similarly, FIG. 2B shows UDP stacked on IP where communications include using UDP packets.

Other protocols may be stacked on TCP and/or UDP. In one example, a hypertext transfer protocol (HTTP) may be stacked on TCP which may be stacked on IP, as shown in FIG. 2C. In another example, a real time protocol (e.g., SIP, H.323, streaming audio and/or video protocol, etc.) may be stacked on UDP which is stacked on IP, as illustrated in FIG. 2D.

In some embodiments, a real time protocol (e.g., SIP, H.323, streaming audio and/or video protocol, etc.) may be stacked on UDP, thereby creating a real time protocol/UDP stack which may be then be stacked on a TCP/IP stack as shown in FIG. 2E. Using a configuration such as this may allow one or more endpoints 103D-103F to communicate with network 101 using the real time protocol/UDP stack configuration if gateway 130B blocks either the real time protocol or UDP. This is described in further detail below.

In some embodiments, a real time protocol (e.g., SIP, H.323, streaming audio and/or video protocol, etc.) stacked on UDP, thereby creating a real time protocol/UDP stack, may then be stacked on a HTTP/TCP/IP stack as shown in FIG. 2F. Using a configuration such as this may allow one or more endpoints 103D-103F to communicate with network 101 using the real time protocol/UDP stack configuration if gateway 130B blocks any protocol except HTTP. In various embodiments, HTTPS (secure HTTP) may be used instead of or in addition to HTTP.

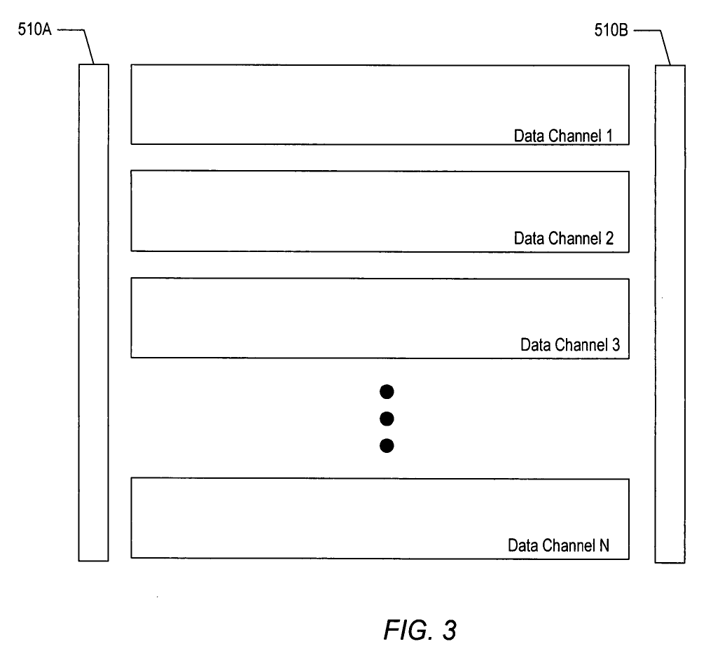

FIG. 3—Communicating Using a First Protocol Over Multiple Data Channels of a Second Protocol

FIG. 3 is a block diagram illustrating communicating using a first protocol over multiple data channels of a second protocol, according to various embodiments. Any number of N data channels of the second protocol may be used as shown in FIG. 3. In various embodiments, any number of N data channels of the second protocol may be used based on various configurations.

In various embodiments, one or more packets of the first protocol may arrive at an interface 510A and be sent via any number of N data channels of the second protocol to an interface 510B, and/or one or more packets of the first protocol may arrive at interface 510B and be sent via any number of N data channels of the second protocol to interface 510A. Each data channel may be a network data socket that couples interfaces 510A and 510B via various networks (e.g., network 101, PSTN 120, the Internet, etc.). In some embodiments, interface 510A may be coupled to or included in a first computer system or an endpoint (e.g., one of endpoints 103A-103H) and an interface 510B may be coupled to or included in a second computer system or a service provider 107.

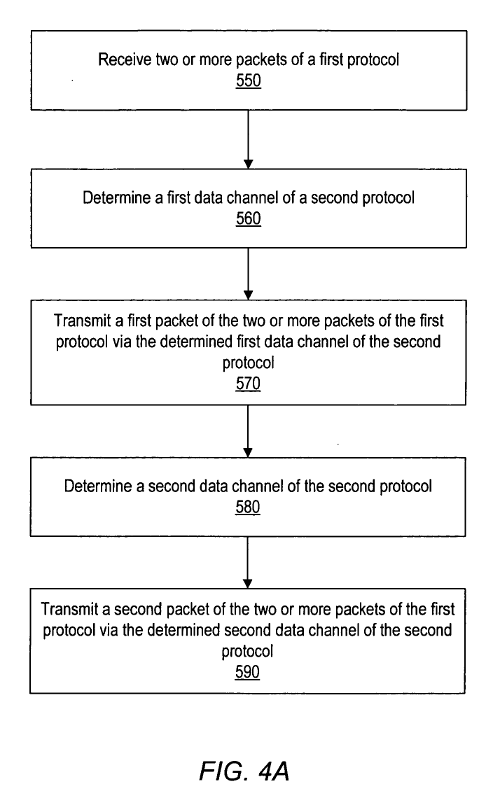

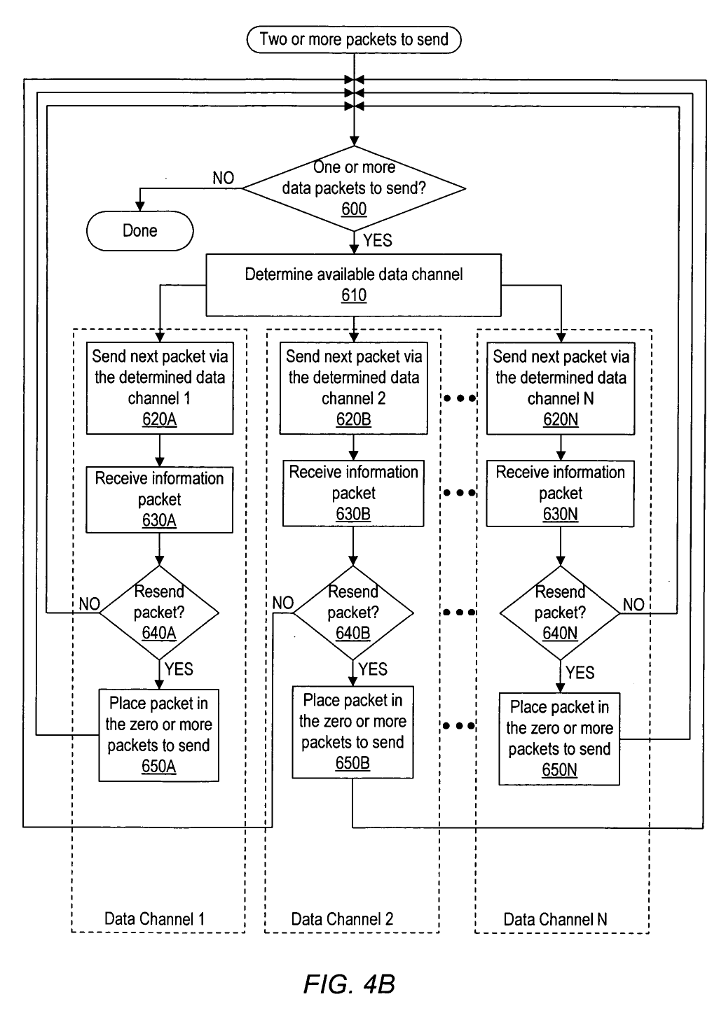

FIGS. 4A-4B—Methods for Communicating Using a First Protocol Over Multiple Data Channels of a Second Protocol

FIG. 4A is a flowchart diagram illustrating a method for communicating using a first protocol over multiple data channels of a second protocol, according to various embodiments. It is noted that in various embodiments one or more of the method elements may be performed concurrently, in a different order, or omitted. Additional method elements may be performed as desired.

As indicated at 550, two or more packets of a first protocol may be received. For example, the two or more packets of the first protocol may be received may be received at a first interface (e.g., interface 510A of FIG. 3). In various embodiments, each data channel of two or more data channels of a second protocol (e.g., the data channels of FIG. 3) may couple the first interface to a second interface (e.g., interface 510B of FIG. 3) via various networks (e.g., network 101, PSTN 120, the Internet, etc.). In some embodiments, the two or more packets of the first protocol may include data of a real time protocol (e.g., SIP, H.323, streaming audio and/or video protocol, etc.).

At 560, a first data channel of the two or more data channels (e.g., network data sockets) of the second protocol may be determined. A first packet of the two or more packets of the first protocol may be transmitted via the first data channel, as indicated at 570. For example, the first packet of the two or more packets of the first protocol may be transmitted to the second interface via various networks (e.g., network 101, PSTN 120, the Internet, etc.).

At 580, a second data channel of the two or more data channels of the second protocol may be determined. A second packet of the two or more packets of the first protocol may be transmitted via the second data channel, as indicated at 590. For example, the second packet of the two or more packets of the first protocol may be transmitted to the second interface via various networks (e.g., network 101, PSTN 120, the Internet, etc.).

In some embodiments, various error resiliency schemes may be used. Further embodiments of communicating using a first protocol over multiple data channels of a second protocol are described with reference to FIG. 4B.

FIG. 4B is a flowchart diagram illustrating a method for communicating using a first protocol over multiple data channels of a second protocol, according to various embodiments. It is noted that in various embodiments one or more of the method elements may be performed concurrently, in a different order, or omitted. Additional method elements may be performed as desired.

As indicated at 600, it may be determined if one or more packets of a first protocol are to be sent. For example, one or more data packets of the first protocol may arrive at an interface. In some embodiments, the first protocol packets may include data from a real time protocol (e.g., SIP, H.323, streaming audio and/or video protocol, etc.). For instance, the first protocol may include UDP packets that include data from the real time protocol (e.g., SIP, H.323, streaming audio and/or video protocol, etc.). If it is determined that there are not one or more packets of the first protocol are to be sent, the method may complete. If there are one or more packets of the first protocol to be sent, a data channel may be determined from N data channels, as indicated at 610. Any number of N data channels of the second protocol may be used as shown in FIGS. 3 and 4B. In various embodiments, any number of N data channels of the second protocol may be used based on various configurations. Each data channel of the N data channels may be controlled and/or operated by a respective thread and/or process, and each respective thread and/or process may be synchronized with other threads and/or processes or may perform in an asynchronous manner with respect to other threads and/or processes.

In some embodiments, a data channel may not be available. In an example, the data channel may be already utilized in communicating data. In another example, the data channel may become slow (according to some metric), error-prone (according to some metric), or otherwise not desirable to use based on some configuration and/or metric. Thus, in some embodiments, a data channel may not be available for various reasons.

It is noted that the description, below, for elements 620A-660A with reference to data channel 1 may be applied equally to elements 620B-660B and 620N-660N with reference to data channels 2 and N, respectively.

At 620A, a packet of the first protocol may be sent via determined data channel 1. In some embodiments, one or more packets of the second protocol may include the packet of the first protocol sent via data channel 1. In an example, the second protocol may include TCP, and one or more TCP packets may include the packet of the first protocol sent via determined data channel 1. In another example, the second protocol may include HTTP, and one or more HTTP packets may include the packet of the first protocol sent via determined data channel 1. In various embodiments, the second protocol may include transport layer security (TLS), HTTPS (secure HTTP), and/or a secure socket layer (SSL), among other security methods and/or mechanisms. For instance, one or more HTTPS packets may include the packet of the first protocol sent via determined data channel 1.

At 630A, information may be received via data channel 1. For example, a packet of the second protocol may be received from a second interface via data channel 1. For instance, the packet may include the information, and the information may indicate whether or not the packet of the first protocol was received correctly and/or whether or not the packet should be resent. In some embodiments, it may or may not be desirable to resend lost or corrupted data packets. For example, resending data packets associated with an audio and/or video stream may not be desirable, since resending data packets may introduce an undesirable delay to the audio and/or video stream. As indicated at 640A, it may be determined if the packet of the first protocol is to be resent. If it is determined that the packet of the first protocol is not to be resent, the method may proceed to 600. If the packet of the first protocol is not to be resent, the packet of the first protocol may be included with zero or more packets to be sent, as indicated at 650A, and the method may proceed to 600.

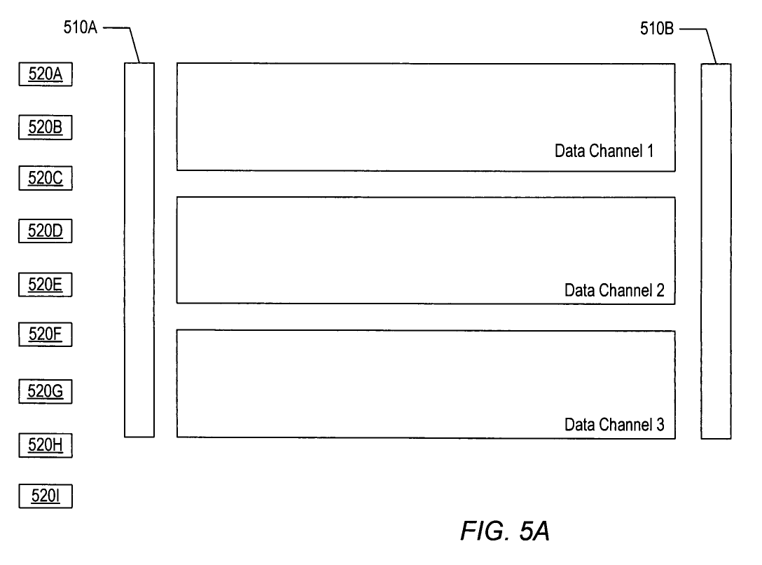

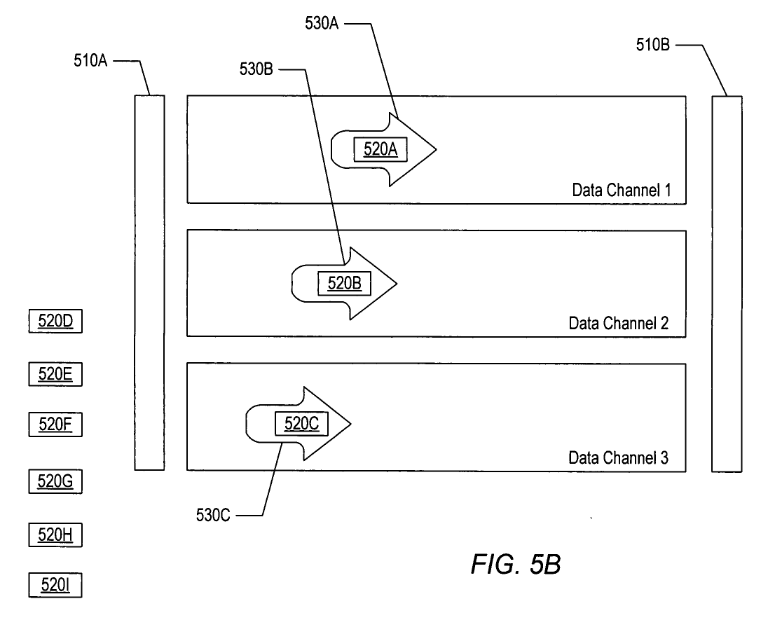

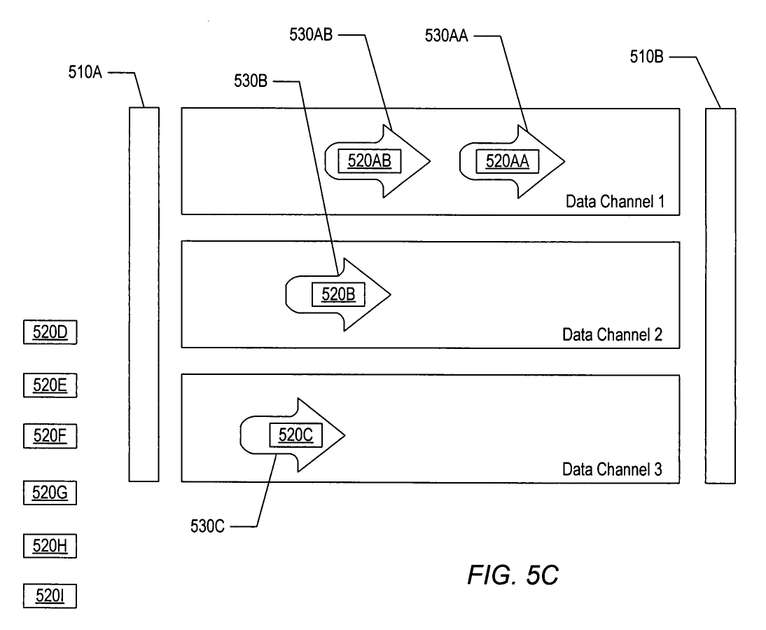

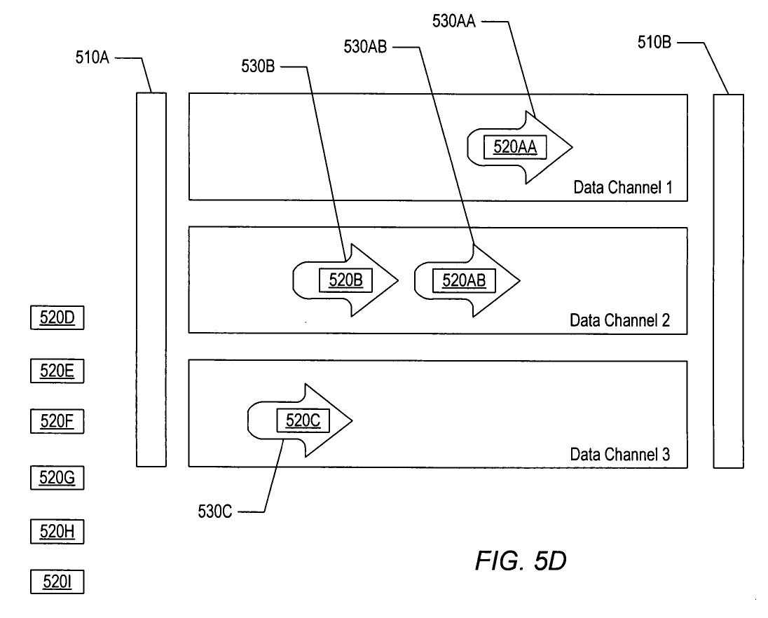

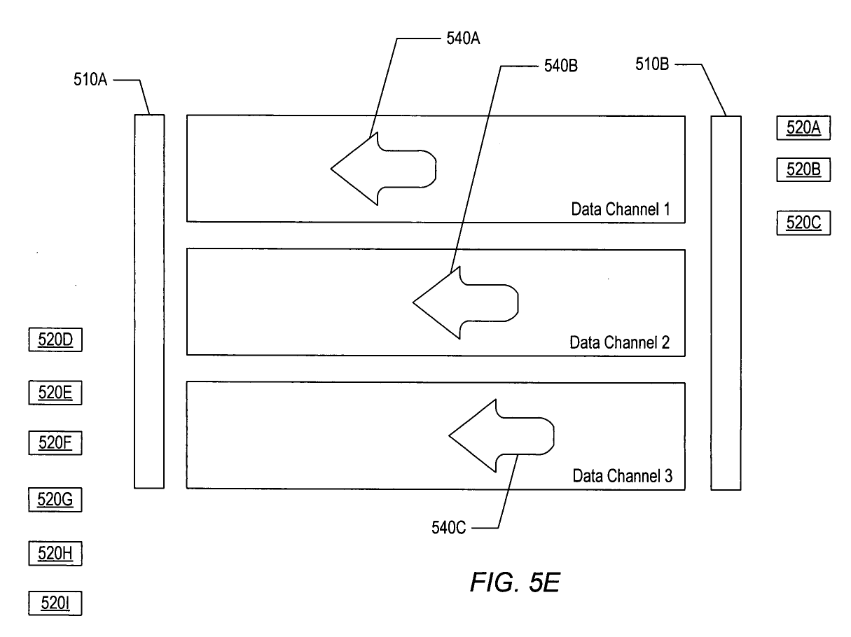

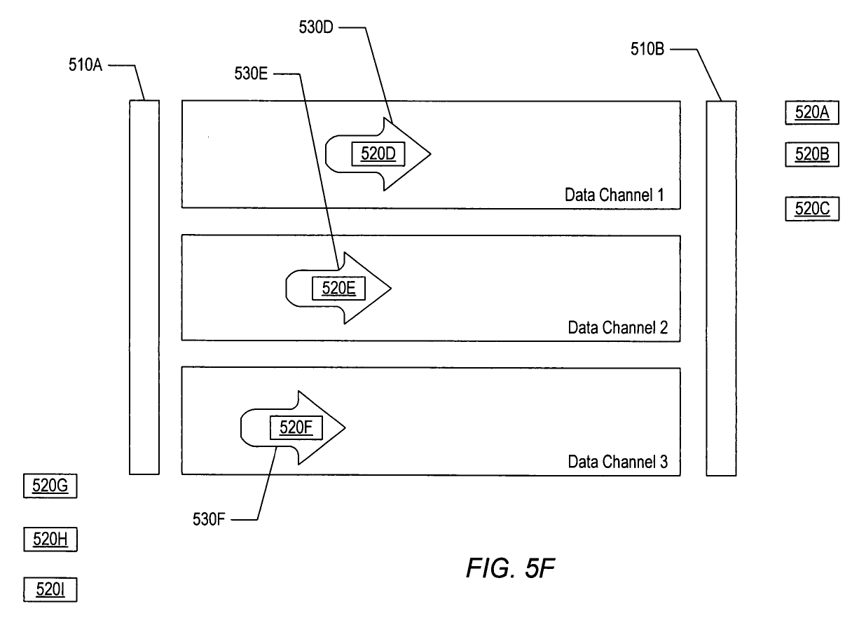

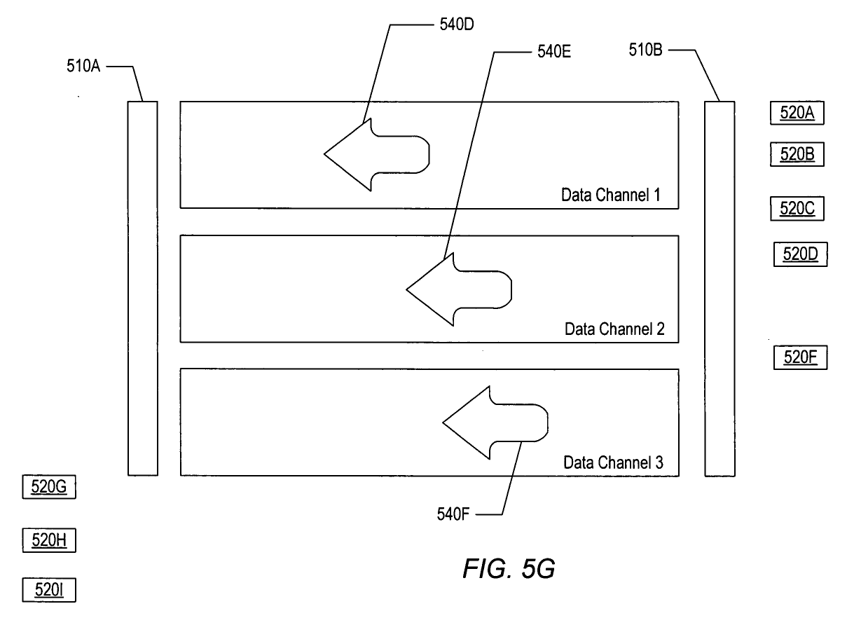

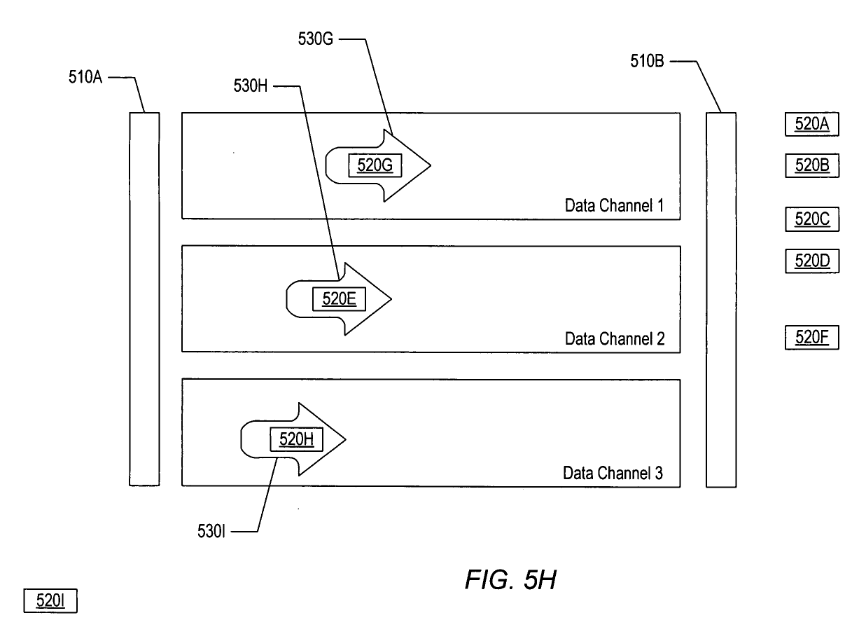

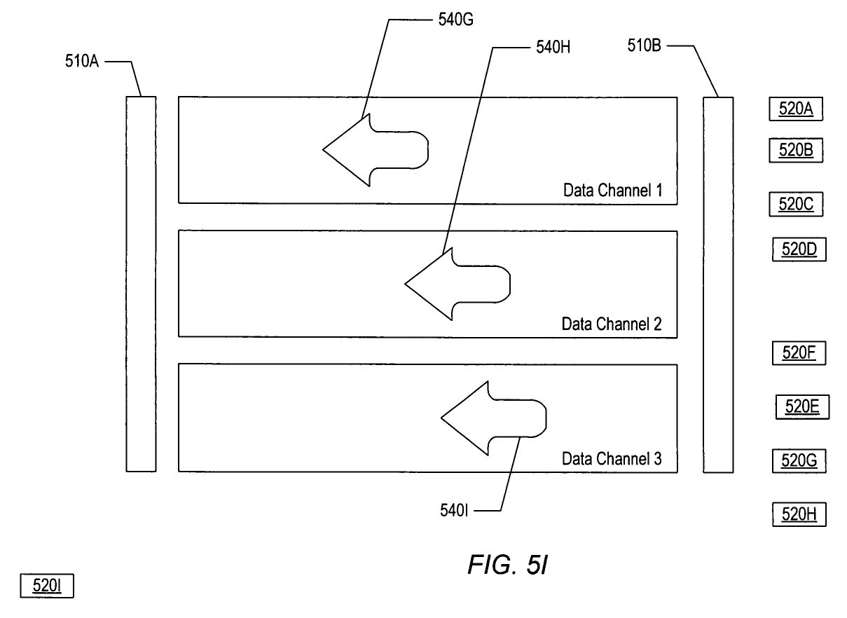

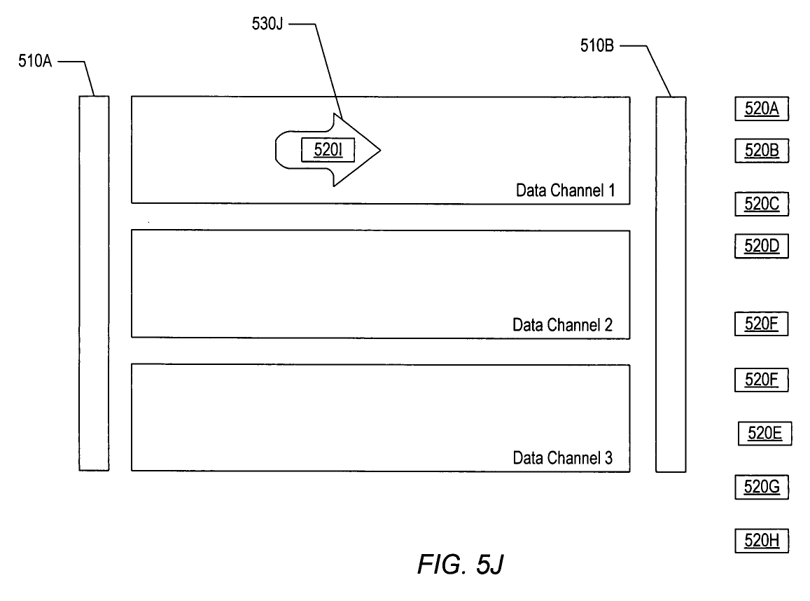

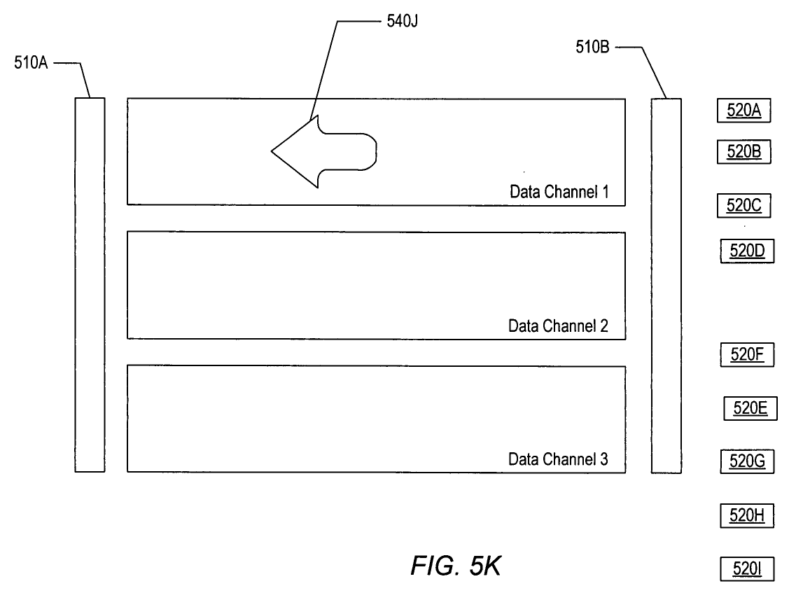

FIG. 5A-5I—Example of Communicating Using a First Protocol Over Multiple Data Channels of a Second Protocol

FIGS. 5A-5K are a block diagrams illustrating various aspects of communicating using a first protocol over multiple data channels of a second protocol, according to various embodiments. FIGS. 5A-5K illustrate using three data channels of the second protocol by way of example and not by limitation.

As shown in FIG. 5A, one or more packets 520A-520I of the first protocol may arrive at interface 510A. For example, the one or more packets 520A-520I of the first protocol may include UDP packets that include data from a real time protocol (e.g., SIP, H.261, H.263, H.264, H.323, streaming audio and/or video protocol, etc.).

As shown in FIG. 5B, each of the packets 520A-520C of the first protocol may be sent over data channels 1-3, respectively, and each of the data packets 520A-520C may be included in packets 530A-530C, respectively, of the second protocol. In an example, packets 530A-530C may include TCP packets where the second protocol includes TCP. In another example, packets 530A-530C may include HTTP packets where the second protocol includes HTTP. In various embodiments, one or more secure methods, secure systems, and/or secure techniques for communicating information. For example, the second protocol may include a transport layer security (TLS), HTTPS (secure HTTP), and/or a secure socket layer (SSL). For instance, data packets 530A-530C may include HTTPS packets where the second protocol includes HTTPS.

In some embodiments, the second protocol may include a maximum transfer unit or maximum amount of data which may be sent in a packet of the second protocol, and each of one or more data packets of the first protocol may be split into two or more portions, and the two or more portions may be sent over one or more data channels. For example, packet 520A may be split into portions 520AA and 520AB. In an instance, as shown in FIG. 5C, portions 520AA and 520AB may be sent via data packets 530AA and 530AB of the second protocol, respectively, through data channel 1. In another instance, as shown in FIG. 5D, portions 520AA and 520AB may be sent via packets 530AA and 530AB, respectively, of the second protocol, and packets 530AA and 530AB of the second protocol may be sent through data channels 1 and 2, respectively.

As shown in FIG. 5E, packets 520A-520C of the first protocol may be received through interface 510B. In some embodiments, packets 540A-540C of the second protocol may be sent to interface 510A. For example, each of the packets 540A-540C may include information such as acknowledgements (e.g., “ACKs”) indicating that packets 520A-520C were delivered through interface 510B correctly and/or in a timely manner.

FIG. 5F illustrates each of the packets 520D-520F may be included in packets 530D-530F, respectively, of the second protocol and sent from interface 510A to interface 510B.

As shown in FIG. 5G, packets 520D and 520F of the first protocol may be received through interface 510B. In some embodiments, packets 540D-540F of the second protocol may be sent to interface 510A. For example, each of the packets 540D and 540F may include information such as acknowledgements (e.g., “ACKs”) indicating that packets 520D and 520F were delivered through interface 510B, and data packet 540E may include information such as an error or non-acknowledgement (e.g., “NAK”) indicating that packet 520E was not delivered through interface 510B correctly and/or in a timely manner. For instance, a timeout may have occurred before 530E arrived at interface 510B.

In some embodiments, data packet 520E may not be resent, and any packets of the first protocol remaining to be sent through interface 510B may proceed to be sent. In various embodiments, packet 520E may be resent. As shown in FIG. 5H, each of the packets 520G, 520E, and 520H may be included in packets 530G-530I, respectively, of the second protocol.

As shown in FIG. 5I, packets 520G, 520E, and 520H may be received through interface 510B. In some embodiments, packets 540G-540I of the second protocol may be sent to interface 510A. For example, each of the packets 540G-540I may include information such as acknowledgements (e.g., “ACKs”) indicating that packets 520G, 520E, and 520H were delivered through interface 510B.

As illustrated in FIG. 5K, packet 520I may be included in packet 530J. FIG. 5K shows packet 520I may be received through interface 510B, and, that in some embodiments, packet 540J of the second protocol may be sent to interface 510A. Packet 540J may include information such as an ACK indicating that packet 520I was delivered through interface 510B.

FIG. 6—A Method for Using a Service Provider to Communicate with a Computer System

FIG. 6 is a flowchart that illustrates a method for using a service provider to communicate with a computer system, according to various embodiments. It is noted that in various embodiments one or more of the method elements may be performed concurrently, in a different order, or omitted. Additional elements may be performed as desired.

In some embodiments, it may be desirable for the first endpoint (e.g., one of endpoints 103C and 103D-103F) coupled to a gateway (e.g., one of gateways 130A-130B) to communicate with a second computer (e.g., one of endpoints 103A-103B, 103G-103H, conference units 105C-105D, etc.) using a first protocol (e.g., UDP, NETBIOS™, AppleTalk™, Internet control message protocol (ICMP), and/or Internetwork Packet Exchange (IPX), etc.), and the gateway may not permit the first endpoint to communicate using the first protocol with network 101 and/or computer systems coupled to network 101. However, the gateway may permit the first endpoint to use a second protocol to communicate with network 101 and/or computer systems coupled to network 101. For instance, the second protocol may include TCP, HTTP, and/or HTTPS, among others.

At 661, the first endpoint coupled to the gateway (e.g., one of gateways 130A-130B) may establish a session with service provider 107 via network 101. The endpoint may establish the session using the second protocol. In various embodiments, the session may include two or more data channels of the second protocol, and the session may transport the first protocol across the two or more data channels such as described above with reference to FIGS. 3-5I.

At 663, the endpoint may send a request to service provider 107. The request may include an address/port pair (outside the gateway) for communicating with the second computer system. For example, service provider 107 may be operable to act as an agent or client on behalf of various computer systems behind the gateway. For instance, service provider 107 may communicate with endpoint 103A, on behalf of endpoint 103C, using the address, port, and the first protocol.

At 665, the first endpoint may send a first set of packets including the first protocol via the session to service provider 107. For instance, the first set of packets may include UDP packets. Service provider 107 may send the first set of packets including the first protocol to the second computer system, as indicated at 667.

At 669, service provider 107 may receive a second set of packets from the second computer system. For instance, the second set of packets may include UDP packets. Service provider 107 may then send the second set of packets to the first endpoint via the session, at 671.

In other words, service provider 107 may perform as a protocol translator between the first endpoint and the second computer system. The first endpoint may use multiple data channels of the second protocol (e.g., TCP, HTTP, HTTPS, etc.) to communicate packets of the first protocol (e.g., UDP, etc.) which may include data from a real time protocol (e.g., SIP, H.261, H.263, H.264, H.323, streaming audio and/or video protocol, etc.) to and from service provider 107, and service provider 107 may use the first protocol (e.g., UDP, etc.) to communicate packets of the first protocol (e.g., UDP, etc.) which may include data from the real time protocol to and from the second computer system.

FIG. 7—Using a Service Provider to Provide Access of a Network

FIG. 7 is a flowchart that illustrates a method for using a service provider to provide access of a network, according to various embodiments. It is noted that in various embodiments one or more of the method elements may be performed concurrently, in a different order, or omitted. Additional elements may be performed as desired.

In some embodiments, a gateway (e.g., one of gateways 130A-130B) may be using NAT in communicating data with network 101 and various endpoints coupled to the gateway. For example, endpoints 103D-103F may use private IP addresses that may not be recognized by network 101 and/or computer systems coupled to network 101. Furthermore, gateway 130B may use NAT to enable a single public address (e.g., a single public IP address) to be used by endpoints 103D-103F to make outgoing connections to network 101 and/or computer systems coupled to network 101. In some embodiments, connections incoming from network 101 and/or computer systems coupled to network 101 to the single public address may not be used by endpoints 103D-103F, since it may be difficult to differentiate which endpoint is to receive the incoming connection. Furthermore, gateway 130B may be configured to block any connections which are incoming to endpoints 103D-103F. In some embodiments, service provider 107 may be used to provide access of a network to one or more computer systems (e.g., one or more of endpoints 103D-103F) that are coupled to a gateway (e.g., gateway 130B).

In some embodiments, service provider 107 may include one or more mechanisms to obtain a public address (e.g., a publicly routable address), “listen” for incoming traffic sent to the public address, and send incoming traffic to a computer system (e.g., a privately addressed endpoint) coupled to a gateway.

At 701, a first endpoint (e.g., endpoint 103D) coupled to a gateway (e.g., gateway 130B) may establish a session with service provider 107 via network 101. In some embodiments, the first endpoint may communicate with other endpoints using a first protocol, and the session may include two or more data channels of a second protocol. The session may transport the first protocol across the two or more data channels such as described above with reference to FIGS. 3-5I. In various embodiments, service provider 107 may be configured to act as an agent or client on behalf of various computer systems coupled the gateway.

At 703, the first endpoint may send a request to service provider 107. The request may include a request for a public address (e.g., a publicly routable address) and a desired protocol (e.g., TCP, UDP, HTTP, etc.) to be used with the public address when computer systems outside firewall 907 are communicating with the public address. For example, the public address may be an address that is available on network 101 and may be used for communicating information to and/or from network 101.

At 705, service provider 107 may allocate the public address for the first endpoint. For example, in response to the request, service provider 107 may allocate the public address (which may be a network address available on network 101).

In some embodiments, one or more ports may be used by service provider 107 to receive information from various network (e.g., network 101, PSTN 120, the Internet). Furthermore, each port may be associated with an integer number, such as 1, 2, 3, etc. In various examples, a port associated with number 25 may be used to receive electronic mail, a port associated with number 80 may be used to receive a world wide web request (e.g., a HTTP request), a port associated with number 443 may be used to receive a secure world wide web request (e.g., a HTTPS request), a port associated with number 110 may be used to post office protocol electronic mail (POP Mail) requests, etc. Service provider 107 may allocate one or more ports and associate numbers of the one or more ports with the public address allocated to the first endpoint.

At 707, service provider 107 may create a mapping using information from the session, the public address, and the one or more ports associated with the public address. The mapping may include information usable by service provider 107 to associate traffic and/or data received via the public address and the one or more ports with the session. In various embodiments, service provider 107 may use a data structure to store information associated with the mapping.

At 709, service provider may send a response to the first endpoint that includes information associated with the public address and port(s) allocated for the first endpoint.

At 711, service provider 107 may receive data (e.g., an incoming connection from network 101 and/or a computer system coupled to network 101) via the one or more ports of the public address allocated to the first endpoint. In some embodiments, service provider may use information of the mapping and/or associated with the mapping to determine how to process the data received via the one or more ports and the public address.

At 713, service provider 107 may send the data received via the one or more ports of the public address allocated to the first endpoint to the first endpoint via the session.

FIG. 8—Transcoding Real Time Protocols

FIG. 8 is a flowchart that illustrates a method for transcoding real time protocols, according to various embodiments. It is noted that in various embodiments one or more of the method elements may be performed concurrently, in a different order, or omitted. Additional elements may be performed as desired.

As indicated at 681, a first real time protocol may be received. For example, the first real time protocol may include one of SIP, H.261, H.263, H.264, H.320, H.323, streaming audio and video protocol, among others. In some embodiments, service provider 107 may receive the first real time protocol. In various embodiments, service provide may receive a real time protocol such as H.320 from either of conference units 105A-105B coupled to PSTN 120.

At 683, the first real time protocol may be transcoded into a second real time protocol, where the second real time protocol differs from the first real time protocol. In some embodiments, transcoding the first real time protocol into the second real time protocol may include a process of converting the first real time protocol into the second real time protocol. For example, data from a first codec associated with the first real time protocol to data of a second codec associated with the second real time protocol. In other words, transcoding may include a process of converting media data or object from one format to another. In various embodiments, transcoding may be used to convert video formats. For example, transcoding may be used to convert Windows Media™ to QuickTime™, QuickTime™ to MPEG, MPEG to QuickTime™, etc.

In an example, service provider 107 may transcode H.323 into H.320. In another example, service provider 107 may transcode H.320 into one or more of SIP, H.323, streaming audio and video protocol, among others. In yet another example, service provider 107 may transcode one or more of SIP, H.323, streaming audio and video protocol, among others, to H.320. Audio protocols such as G.711, G.728, G.723, G.729, G.722, G.722.1, G.722.1 Annex C, MPEG-4-AAC and others may also be transcoded.

At 685, service provider 107 the second real time protocol may be transmitted to network 101 (e.g., to one or more of endpoints 103A-103H coupled to network 101).

Embodiments of these methods may be implemented by program instructions stored in a memory medium or carrier medium. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, the computer system may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed:

1. A computer-implemented method, comprising:
receiving a plurality of packets of a first protocol at a first interface, wherein the plurality of packets of the first protocol comprise data of a real time protocol which is associated with audio and/or video conferencing information;
determining a first data channel of a plurality of data channels of a second protocol;
transmitting a first packet of the plurality data packets of the first protocol via the determined first data channel to a second interface;
determining a second channel of the plurality of data channels of the second protocol; and
transmitting a second packet of the plurality data packets of the first protocol via the determined second data channel to the second interface;
wherein each of the plurality of data channels couples the first interface and the second interface via a network.

2. The method of claim 1, wherein the real time protocol comprises one or more of session initiation protocol (SIP), H.261, H.263, H.264, and H.323.

3. The method of claim 1, wherein the first protocol comprises a user datagram protocol (UDP).

4. The method of claim 1, wherein a service provider is coupled to the second interface.

5. The method of claim 1,
wherein the first interface and the second interface are coupled through a gateway, and
wherein the gateway comprises one or more of a firewall, a packet filter, and a network address translation mechanism.

6. The method of claim 5, wherein the gateway is configured to block the first protocol.

7. A device, comprising:
a processor;
a first port coupled to the processor, wherein the first port is operable to be coupled to a network; and
a memory medium coupled to the processor, wherein the memory medium comprises program instructions which are executable by the processor to:
receive data from the network via the first port, wherein, in said receiving the data, the program instructions are further executable by the processor to receive the data via a first real time protocol; and
transmit the data to the network via the first port, wherein, in said transmitting the data, the program instructions are further executable by the processor to transmit the data via a second real time protocol; and
wherein the first real time protocol is different from the second real time protocol.

8. The device of claim 7, wherein the program instructions which are further executable by the processor to:
transcode the first real time protocol into the second real time protocol.

9. The device of claim 8, wherein the data comprises first audio information which is encoded with a first codec associated with the first real time protocol;
wherein, in said transcoding, the program instructions are further executable to convert the first audio information into second audio information which is encoded with a second codec associated with the second protocol.

10. The device of claim 8, wherein the data comprises first video information which is encoded with a first codec associated with the first real time protocol;
wherein, in said transcoding, the program instructions are further executable to convert the first video information into second video information which is encoded with a second codec associated with the second protocol.

11. The device of claim 7, wherein the data comprises audio information;
the device further comprising:
a second port coupled to the processor, wherein the second port is operable to be coupled to an audio output device;
wherein the program instructions are further executable by the processor to:
transmit the audio information to the audio output device; and
wherein the audio output device is operable to output audio signals based on the audio information.

12. The device of claim 7, wherein the data comprises audio information;
the device further comprising:
an audio output device coupled to the processor;
wherein the program instructions are further executable by the processor to:
transmit the audio information to the audio output device; and
wherein the audio output device is operable to output audio signals based on the audio information.

13. The device of claim 7, wherein the data comprises video information;
the device further comprising:
a second port coupled to the processor, wherein the second port is operable to be coupled to a video output device;
wherein the program instructions are further executable by the processor to:
transmit the video information to the audio output device; and
wherein the video output device is operable to output video signals based on the video information.

14. The device of claim 7, wherein the data comprises video information;
the device further comprising:
a video output device coupled to the processor;
wherein the program instructions are further executable by the processor to:
transmit the video information to the video output device; and
wherein the video output device is operable to output video signals based on the video information.

15. A system, comprising:
a computer system, wherein the computer system is operable to communicate using at least a first real time protocol and a second real time protocol, wherein the first real time protocol is different from the second real time protocol;
a first conference unit coupled to the computer system, wherein the first conference unit is operable to communicate with the computer system using the first real time protocol; and
a second conference unit coupled to the computer system, wherein the second conference unit is operable to communicate with the computer system using the second real time protocol;
wherein the computer system is further operable to receive data from the first conference unit via the first real time protocol and transmit the data to the second conference unit via the second real time protocol.

16. The system of claim 15, further comprising:
an audio output device coupled to the computer system, wherein the audio output device is operable to output audio signals;
wherein the data from the first conference unit comprises audio information;
wherein the computer system is further operable to output the audio information via the audio output device.

17. The system of claim 15, further comprising:
an video output device coupled to the computer system, wherein the video output device is operable to output video signals;
wherein the data from the first conference unit comprises video information; and
wherein the computer system is further operable to output the video information through the video output device.

18. The system of claim 15, further comprising:
an audio input device coupled to the computer system, wherein the audio input device is operable to receive audio signals;
wherein the computer system is further operable to:
receive first audio information from the audio input device;
transmit first data comprising second audio information to the first conference unit via the first real time protocol, wherein the second audio information is based on the first audio information and the first real time protocol; and
transmit second data comprising third audio information to the second conference unit via the second real time protocol, wherein the third audio information is based on the first audio information and the second real time protocol.

19. The system of claim 15, further comprising:
a video input device coupled to the computer system, wherein the video input device is operable to receive video signals;
wherein the computer system is further operable to:
receive video information from the video input device;
transmit first data comprising the video information to the first conference unit via the first real time protocol; and
transmit second data comprising the video information to the first conference unit via the second real time protocol.

20. The system of claim 15,
wherein the computer system and the first conference system are coupled through a network; and
wherein the computer system and the second conference system are coupled through the network.
